(19) United States
(12) Patent Application Publication
(10) Pub. No.: US 2014/0054810 A1
(43) Pub. Date: Feb. 27, 2014

(54) METHOD FOR REFURBISHING AN AIRCRAFT BRAKE DISK

(71) Applicant: DACC CO., LTD, Changwon (KR)

(72) Inventors: Chae Wook CHO, Daejeon (KR); Jong Hyun PARK, Jeonju (KR); Kap Su JUNG, Jeonju (KR)

(73) Assignee: DACC CO., LTD, Changwon (KR)

(21) Appl. No.: 13/804,609

(22) Filed: Mar. 14, 2013

(30) Foreign Application Priority Data
Aug. 27, 2012 (KR) 10-2012-0093705

(51) Int. Cl. B29C 73/02

(52) U.S. Cl. CPC B29C 73/02
USPC 264/36.18

(57) ABSTRACT

Provided is a method for refurbishing an aircraft brake disk, the method comprising: removing a worn disk from the aircraft brake disk when the disk is worn out up to a set wear amount (Step 1); filling a first mixture in a mold to be a first refurbishment height (Step 2); putting the worn disk on the first mixture (Step 3); filling a second mixture on the worn disk in the mold to be a second refurbishment height (Step 4); pressurizing the first mixture, the worn disk, and the second mixture with a press at once to prepare a molded object (Step 5); removing the molded object from the mold, and then carbonizing the molded object (Step 6); and densifying the carbonized molded object (Step 7), in which the worn disk is subjected to Steps 1 to 7 to prepare a refurbished disk.

### CROSS-REFERENCE TO RELATED APPLICATIONS

This application claims the priority of Korean Patent Application No. 10-2012-0093705 filed on Aug. 27, 2012, in the Korean Intellectual Property Office, the disclosure of which is incorporated herein by reference.

### BACKGROUND OF THE INVENTION

1. Field of the Invention

The present invention relates to a method for refurbishing an aircraft brake disk.

2. Description of the Related Art

The temperature of friction surface of an aircraft brake disk increases to 1,000° C. or more at the time of landing an aircraft. Therefore, the aircraft brake disk is made with a carbon-carbon composite so as not to deteriorate frictional force or mechanical strength at such a high temperature.

For a carbon-carbon composite, frictional force or mechanical strength is not deteriorated even at a high temperature of 2,500° C. or more, and also the carbon-carbon composite is a material having excellent thermal shock resistance and thermal conductivity.

Since the price of such a carbon-carbon composite is high as compared with a metallic material, an aircraft brake disk is refurbished and then used many times in order to reduce costs.

A method for refurbishing an aircraft brake disk is disclosed in U.S. Pat. No. 7,900,751 B2 filed by Honeywell.

The patent filed by Honeywell discloses a method for preparing a refurbished disk, the method including mechanical working two worn disks, and then combined together with a bolt or adhesive. However, such a method for preparing a refurbished disk has a limitation in that it is only possible to refurbish a worn disk maximum 3 times. In addition, since two worn disks are refurbished by combining them together with a bolt or adhesive, there is a risk that a refurbished disk may be disassembled during a brake operation.

### SUMMARY OF THE INVENTION

The present invention was invented for solving the aforementioned problems. An object of the present invention is to provide a method for refurbishing an aircraft brake disk, in which there is no limit on the number of refurbishment for a worn disk.

In addition, an object of the present invention is to provide a method for refurbishing an aircraft brake disk having low disassemblability of a refurbished disk during a brake operation.

In order to achieve the above objects, a method for refurbishing an aircraft brake disk is provided, in which a plurality of rotator disks or stator disks are alternately arranged in the aircraft brake disk, the method including:

removing a worn disk from the aircraft brake disk when a disk is worn out up to a set wear amount (Step 1);

filling a first mixture prepared by mixing a carbon fiber and a phenol resin in a mold to be a first refurbishment height (Step 2);

putting the worn disk on the first mixture (Step 3);

filling a second mixture prepared by mixing a carbon fiber and a phenol resin on the worn disk in the mold to be a second refurbishment height (Step 4);

pressurizing the first mixture, the worn disk, and the second mixture with a press at once to prepare a molded object that is divided into a lower layer composed of the first mixture, a middle layer composed of the worn disk, and a higher layer composed of the second mixture (Step 5);

removing the molded object from the mold, and then carbonizing the molded object (Step 6); and

densifying the carbonized molded object (Step 7),

in which the worn disk is subjected to Steps 1 to 7 to prepare a refurbished disk, and when the refurbished disk is worn, the worn refurbished disk is again subjected to Steps 1 to 7 to prepare other refurbished disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a method for refurbishing an aircraft brake disk according an embodiment of the present invention;

FIG. 2 is a schematic diagram illustrating an aircraft brake, in which FIG. 2a is a schematic diagram illustrating an aircraft brake having rotor or stator disks having the thicknesses identical to each other and FIG. 2b is a schematic diagram illustrating an aircraft brake having rotor or stator disks having the thicknesses different from each other;

FIG. 3 is a diagram for describing Steps 2 to 5 illustrated in FIG. 1, in which FIG. 3a is a diagram illustrating a state where a first mixture composed of a carbon fiber and a phenol resin is filled in a mold to be a first refurbishment height, FIG. 3b is a diagram illustrating a state where a worn disk is put on the first mixture, FIG. 3c is a diagram illustrating a state where a second mixture mixed with a carbon fiber and a phenol resin is filled on the worn disk in a mold to be a second refurbishment height, and FIG. 3d is a diagram illustrating a state where the first mixture, the worn disk, and the second mixture are pressurized with a press at once to prepare a molded object that is divided into a lower layer, a middle layer, and a higher layer;

FIG. 4 is a diagram for describing Steps 6 and 7 illustrated in FIG. 1, in which FIG. 4a is a diagram illustrating a case where a middle layer of a carbonated molded object is a 2D preform disk and FIG. 4b is a diagram illustrating a state where the carbonated molded object of FIG. 4a is densified; and

FIG. 5 is a diagram for describing Steps 6 and 7 illustrated in FIG. 1, in which FIG. 5a is a diagram illustrating a case where a middle layer of a carbonated molded object is a 3D preform disk and FIG. 5b is a diagram illustrating a state where the carbonated molded object of FIG. 5a is densified.

### DETAILED DESCRIPTION OF THE PREFERRED EMBODIMENT

Hereinafter, a method for refurbishing an aircraft brake disk according to an embodiment of the present invention will be described in detail.

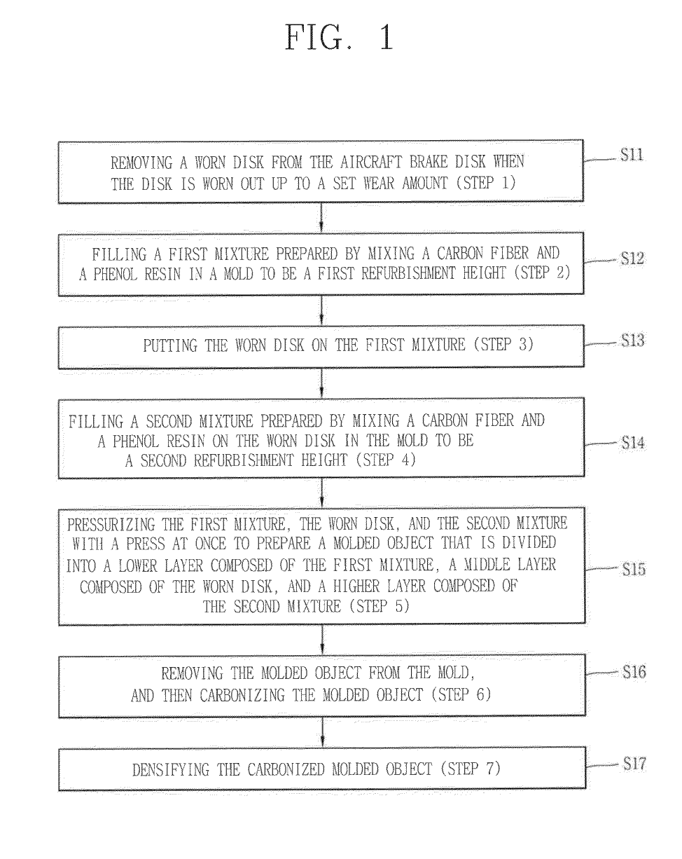

Referring to FIGS. 1 to 5, a method for refurbishing an aircraft brake disk according to an embodiment of the present invention is provided, in which a plurality of rotor disks or stator disks (R, S) are alternately arranged in the aircraft brake disk, the method including:

removing a worn disk (WD) from the aircraft brake disk when a disk (R, S) is worn out up to a set wear amount (Step 1) (S11);

filling a first mixture (X1) prepared by mixing a carbon fiber (Cf) and a phenol resin (Pn) in a mold (M) to be a first refurbishment height (H1) (Step 2) (S12);

putting the worn disk (WD) on the first mixture (X1) (Step 3) (S13);

filling a second mixture (X2) prepared by mixing a carbon fiber (Cf) and a phenol resin (Pn) on the worn disk (WD) in the mold (M) to be a second refurbishment height (H2) (Step 4) (S14);

pressurizing the first mixture (X1), the worn disk (WD), and the second mixture (X2) with a press (P) at once to prepare a molded object (Y1) that is divided into a lower layer (LL) composed of the first mixture (X1), a middle layer (ML) composed of the worn disk (WD), and a higher layer (HL) composed of the second mixture (X2) (Step 5) (S15);

removing the molded object (Y1) from the mold (M), and then carbonizing the molded object (Step 6) (S16); and

densifying the carbonized molded object (Y2) (Step 7) (S17),

in which the worn disk (WD) is subjected to Steps 1 (S11) to 7 (S17) to prepare a refurbished disk (RD), and when the refurbished disk (RD) is worn, the worn refurbished disk is again subjected to Steps 1 (S11) to 7 (S17) to prepare other refurbished disk. Steps 1 (S11) to 7 (S17) constitute one refurbishing cycle.

Hereinafter, Step 1 (S11) will be described.

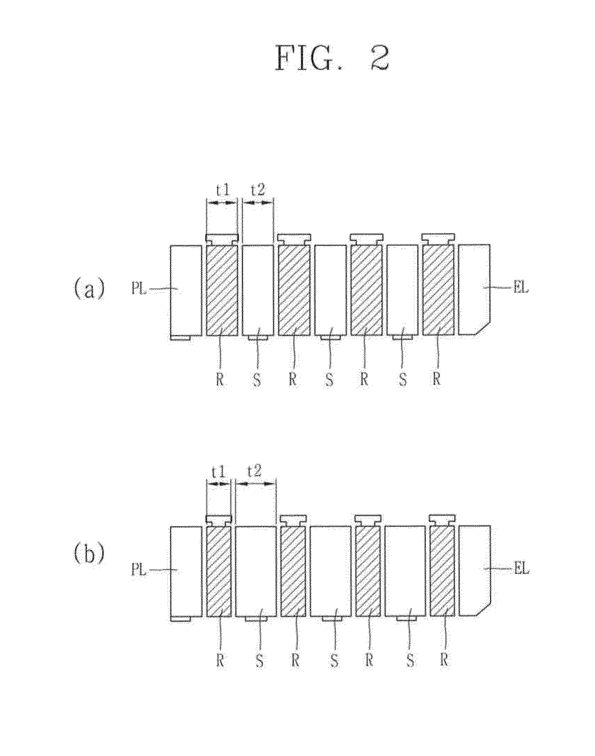

As illustrated in FIGS. 2a and 2b, an aircraft brake is consisted of an endplate (EL), a pressing plate (PL), and a plurality of rotor disks (R) or stator disks (S) that are alternately arranged between the endplate (EL) and pressing plate (PL). Since the detailed configuration of the aircraft brake is disclosed in detail in the patent filed by Honeywell, the description thereof will not be provided.

As illustrated in FIG. 2a, when the thickness (t1) of the rotor disk (R) is identical with the thickness (t2) of the stator disk (S), the rotor disk (R) and stator disk (S) are refurbished in the same refurbishing cycle. According to this embodiment, the thickness (t1) of the rotor disk (R) and the thickness (t2) of the stator disk (S) are 0.8 inches.

As illustrated in FIG. 2b, when the thickness (t1) of the rotor disk (R) is different from the thickness (t2) of the stator disk (S), the thin disk (R) is first refurbished, but the thick disk (S) is used more, and then refurbished in the next refurbishing cycle. According to this embodiment, the thickness (t1) of the rotor disk (R) is 0.7 inches and the thickness (t2) of the stator disk (S) is 0.9 inches. Of course, on the contrary, it is possible that the thickness (t1) of the rotor disk (R) be 0.9 inches and the thickness (t2) of the stator disk (S) be 0.7 inches.

Meanwhile, a method for refurbishing an aircraft brake disk according to an embodiment of the present invention may further include, in order to prepare rotor or stator disks (R, S) before Step 1 (S11), preparing a 2D preform by adding a mixture of a carbon fiber and a phenol resin in a mold and then pressurizing; carbonizing the 2D preform; and densifying the carbonized 2D preform.

Alternatively, a method for refurbishing an aircraft brake disk according to an embodiment of the present invention may further include, in order to prepare rotor or stator disks (R, S) before Step 1 (S11), preparing a 3D preform by laminating a carbon fiber textile and then needle-punching; and densifying the 3D preform.

Hereinafter, Step 2 (S12) will be described.

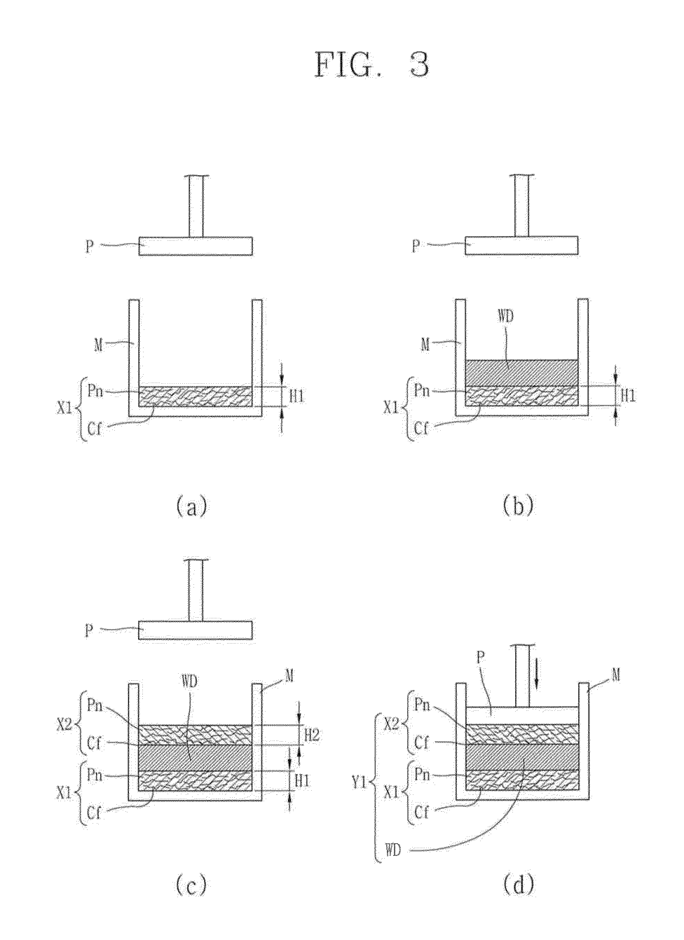

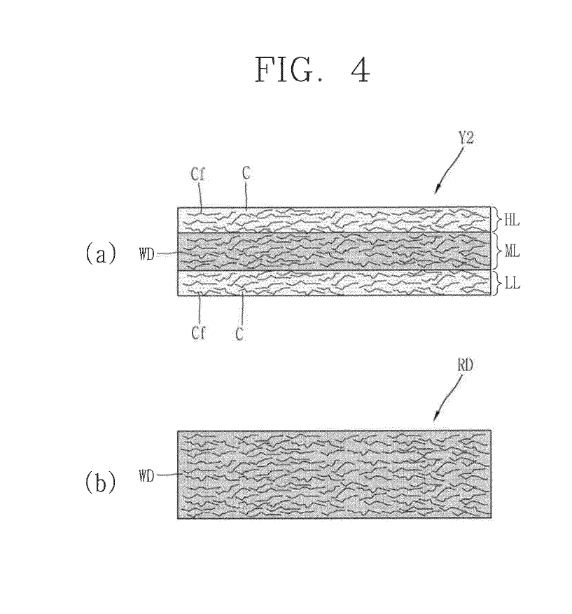

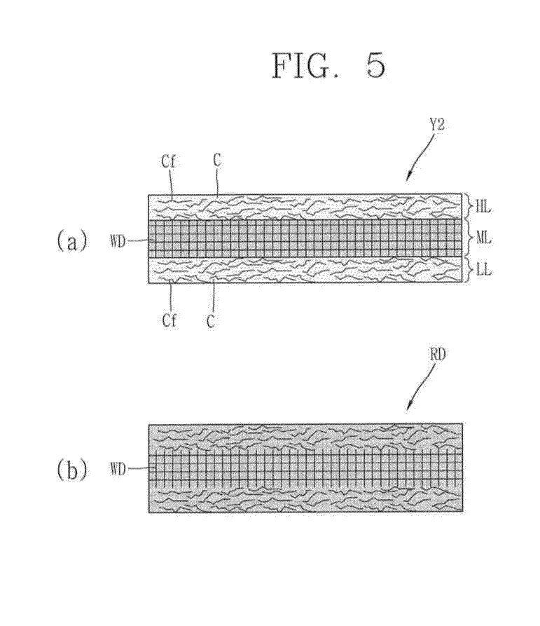

As illustrated in FIG. 3a, a first mixture (X1) mixed of a carbon fiber (Cf) and a phenol resin (Pn) is filled in a mold (M) to be a first refurbishment height (H1). The first mixture (X1) forms a lower layer (LL, see FIGS. 4a and 5a) of a refurbished disk (RD, see FIGS. 4b and 5b).

In order to combine a refurbished disk at the place from which a worn disk is removed, the refurbished disk should have the same thickness as a disk before being worn out. For example, when the thickness of the disk before being worn out is 0.8 inches and acceptable thickness of worn disk is 0.567 inches, the set worn amount is 0.2333 (0.8 minus 0.567) inches. Since the upper side and lower side of the disk are worn out at the same time during a brake operation, each of the thicknesses of the upper side and lower side of the disk to be worn out is 0.1165 (0.2333/2) inches.

Therefore, the first refurbishment height (H1) of the first mixture (X1) forming the lower layer (LL, see FIGS. 4a and 5a) of the refurbished disk is 0.1165 inches, that is, ½ of the set wear amount. However, since the thickness of the lower layer (LL, see FIGS. 4a and 5a) to be cut out at the time of polishing the refurbished disk should be considered, the first refurbishment height (H1) should be larger than ½ of the set wear amount.

Hereinafter, Step 3 (S13) will be described.

As illustrated in FIG. 3b, the worn disk (WD) is put on the first mixture (X1).

Hereinafter, Step 4 (S14) will be described.

As illustrated in FIG. 3c, a second mixture (X2) mixed of a carbon fiber (Cf) and a phenol resin (Pn) is filled on a worn disk (WD) in a mold (M) to be a second refurbishment height (H2). The second mixture (X2) forms a higher layer (HL, see FIGS. 4a and 5a) of the refurbished disk (RD, see FIGS. 4b and 5b). The second refurbishment height (H2) should be larger than ½ of the set wear amount. The reason for this will not be described because it is the same as the reason why the first refurbishment height (H1) should be larger than ½ of the set wear amount.

Hereinafter, Step 5 (S15) will be described.

As illustrated in FIG. 3d, a first mixture (X1), a worn disk (WD), and a second mixture (X2) are pressurized at once by using a press (P) to prepare a molded object (Y1) that is divided into a lower layer (LL) composed of the first mixture (X1), a middle layer (ML) composed of the worn disk (WD), and a higher layer (HL) composed of the second mixture (X2).

Hereinafter, Step 6 (S16) will be described.

Referring to FIGS. 2 to 5, a molded object (Y1) was removed from a mold (M), put into a vacuum resistive heating furnace (not illustrated), and then carbonized. The vacuum resistive heating furnace allows the temperature of the molded object (Y1) to be increased to 1550° C. for 13 hours. The vacuum resistive heating furnace allows the temperature of the molded object (Y1) to be maintained at 1550° C. for 1 to 2 hours. While the temperature of the molded object (Y1) is increased to 1550° C. and then maintained at 1550° C., a phenol resin (Pn) in the molded object (Y1) is pyrolyzed to produce carbon (C).

As illustrated in FIGS. 4a and 5a, for a carbonized molded object (Y2), a carbon amount in a middle layer (ML) is higher than those in a lower layer (LL) and higher layer (HL). The reason why the carbon amount in the middle layer (ML) is higher than those in the lower layer (LL) and higher layer (HL) is because the middle layer (ML) is “a 2D preform disk that is high-densified with carbon at the time of purchasing a product” or “a 3D preform disk that is high-densified with carbon at the time of purchasing a product.” Therefore, it is natural that the middle layer (ML) has a large number of carbon (C) as compared with the higher layer (HL) and lower layer (LL) that are filled with carbon (C) produced during a carbonization process. The differences between the amounts of carbon of the middle layer (ML), and the higher layer (HL) or lower layer (LL) are illustrated in FIGS. 4a and 5a, in which the differences are divided by using light and shade.

Hereinafter, Step 7 (S17) will be described.

A carbonized molded object (Y2) is densified by repeating the process that “a resin (a phenol resin, a furan resin, pitch, and the like) is impregnated into the carbonized molded object (Y2), and then carbonized at a high temperature”. While the densification is progressed, the resins are carbonized, the resulting carbon is filled in the boundaries of the lower layer (LL), middle layer (ML), and higher layer (HL), and thus the lower layer (LL), middle layer (ML) and higher layer (HL) are tightly combined to prepare a refurbished disk (RD) having a single body without the boundaries as illustrated in FIGS. 4b and 5b.

As other densification method, a carbonized molded object (Y2) may be densified by depositing pyrolytic carbon on the carbonized molded object (Y2) with a chemical vapor deposition method. While the densification is progressed, the pyrolytic carbon is filled in the boundaries of the lower layer (LL), middle layer (ML), and higher layer (HL) and thus the lower layer (LL), middle layer (ML) and higher layer (HL) are tightly combined to prepare a refurbished disk (RD) having a single body without the boundaries as illustrated in FIGS. 4b and 5b.

According to the present invention, even though a refurbished disk (RD) is repeatedly produced, a first worn disk (WD) is intactly remained in a middle layer (ML) of the refurbished disk (RD). Since the worn disk (WD) constituting such a middle layer (ML) is “a disk that is densified at the time of purchasing a product,” it is unnecessary to densify the middle layer (ML) again. Therefore, the time required to prepare the refurbished disk (RD) can be reduced as many as the time required to densify the middle layer again.

In addition, according to the present invention, after a refurbished disk (RD) is used until a lower layer (LL) or a higher layer (HL) is worn out, and thus a middle layer (ML) is exposed, the worn refurbished disk (RD) can be subjected to Step 1 (S11) to Step 7 (S17) again to prepare other refurbished disk (RD). Therefore, the worn disk of the middle layer (ML) can continuously be used to prepare a refurbished disk.

In addition, since the worn disk of the middle layer (ML) is refurbished to be a refurbished disk having a single body, the refurbished disk is less likely to be disassembled during a brake operation.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for refurbishing an aircraft brake disk alternately arranging a plurality of rotor disks and stator disks, the method comprising:
removing a worn disk from the aircraft brake disk when the disk is worn out up to a set wear amount (Step 1);
filling a first mixture prepared by mixing a carbon fiber and a phenol resin in a mold to be a first refurbishment height (Step 2);
putting the worn disk on the first mixture (Step 3);
filling a second mixture prepared by mixing a carbon fiber and a phenol resin on the worn disk in the mold to be a second refurbishment height (Step 4);
pressurizing the first mixture, the worn disk, and the second mixture with a press at once to prepare a molded object that is divided into a lower layer composed of the first mixture, a middle layer composed of the worn disk, and a higher layer composed of the second mixture (Step 5);
removing the molded object from the mold, and then carbonizing the molded object (Step 6); and
densifying the carbonized molded object (Step 7),
wherein the worn disk is subjected to Steps 1 to 7 to prepare a refurbished disk, and when the refurbished disk is worn out, the worn refurbished disk is again subjected to Steps 1 to 7 to prepare other refurbished disk.

2. The method for refurbishing an aircraft brake disk according to claim 1, wherein even though the refurbished disk is repeatedly produced, the worn disk is intactly remained in the middle layer of the refurbished disk.

3. The method for refurbishing an aircraft brake disk according to claim 2, wherein when the lower layer or the higher layer of the refurbished disk is worn out, and thus the middle layer is exposed, the refurbished disk is used to prepare other refurbished disk.

4. The method for refurbishing an aircraft brake disk according to claim 1, wherein the first refurbishment height and second refurbishment height are higher than ½ of the set wear amount.

5. The method for refurbishing an aircraft brake disk according to claim 1, further comprising, in order to prepare the plural rotor or stator disks before Step 1, preparing a 2D preform by adding the mixture of the carbon fiber and phenol resin in the mold and then pressurizing; carbonizing the 2D preform; and densifying the carbonized 2D preform.

6. The method for refurbishing an aircraft brake disk according to claim 1, further comprising, in order to prepare the plural rotor or stator disks before Step 1, preparing a 3D preform by laminating a carbon fiber textile and then needle-punching; and densifying the 3D preform.

7. The method for refurbishing an aircraft brake disk according to claim 1, wherein the Steps 1 to 7 constitute one refurbishing cycle,
when the thicknesses of the rotor or stator disks are identical to each other, the rotor or stator disks are refurbished in the same refurbishing cycle, and
when the thicknesses of the rotor or stator disks are different from each other, the thin disk among the rotor or stator disks is first refurbished in the refurbishing cycle, and then the thick disk among the rotor or stator disks is refurbished in the next refurbishing cycle.

8. The method for refurbishing an aircraft brake disk according to claim 1, wherein in Step 7, the carbonized molded object is densified by repeating a process that the resin is impregnated into the carbonized molded object and then carbonized at a high temperature, and
while the carbonization is progressed, a remaining carbon that is produced by carbonizing the resin is filled in boundaries of the lower layer, middle layer, and higher layer to disappear the boundaries.

9. The method for refurbishing an aircraft brake disk according to claim 1, wherein in Step 7, the carbonized molded object is densified by depositing pyrolytic carbon on the carbonized molded object with a chemical vapor deposition method, and
while the densification is progressed, the pyrolytic carbon is filled in the boundaries of the lower layer, middle layer, and higher layer to disappear the boundaries.
